(19) United States
(12) Patent Application Publication
(10) Pub. No.: US 2007/0134531 A1
(43) Pub. Date: Jun. 14, 2007

(54) Fuel cell and method for fabricating same

(76) Inventors: Hidekazu Kimura, Tokyo (JP); Takashi Manako, Tokyo (JP); Hiroshi Kajitani, Tokyo (JP); Kenji Kobayashi, Tokyo (JP); Eiji Akiyama, Tokyo (JP); Tsutomu Yoshitake, Tokyo (JP); Hideyuki Sato, Tokyo (JP); Suguru Watanabe, Tokyo (JP); Takanori Nishi, Tokyo (JP); Yoshimi Kubo, Tokyo (JP); Komei Kato, Tokyo (JP); Takeshi Isobe, Tokyo (JP); Masahiro Wada, Tokyo (JP); Eiko Kanda, Tokyo (JP); Kazuichi Hamada, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/578,194

(22) PCT Filed: Nov. 5, 2004
(86) PCT No.: PCT/JP04/16428

§ 371 Date: Aug. 10, 2006

(30) Foreign Application Priority Data
Nov. 6, 2003 (JP) 2003-376512

(51) Int. Cl. H01M 8/10; H01M 4/86; H01M 4/88; B05D 5/12

(52) U.S. Cl. 429/32; 429/44; 427/115; 502/101

(57) ABSTRACT

[Problems] Miniaturization and weight-saving of a fuel cell including a plurality of unit cells are intended together with higher integration of the unit cells.

[Means for Solving Problems] A pair of electrode sheet 100a, 100b, each having a plurality of fuel electrodes 110a, 110b or a plurality of oxidant electrodes 112a, 112b supported by a resin section 102, are disposed on a single plane on the respective surfaces of a solid electrolyte membrane 105 to configure a plurality of unit cells. The fuel electrode and the oxidant electrode of the adjacent two unit cells existing on the respective surfaces of the solid electrolyte membrane are connected in series by using an electroconductive member penetrating the solid electrolyte membrane. Since the electroconductive member 108 extends along the stacking direction of the cell, no excess space is required to achieve the miniaturization of the fuel cell.

### TECHNICAL FIELD

The present invention relates to a fuel cell having a solid electrolyte membrane on which a plurality of unit cells are disposed, and a method for fabricating the same.

### BACKGROUND ART

A solid polymer electrolyte fuel cell is a power generator in which a fuel electrode and an oxidant electrode are bonded to the respective surfaces of an ion exchange membrane such as a perfluorosulphonic acid membrane acting as electrolyte. The power is generated by an electrochemical reaction which proceeds with the supply of hydrogen to the fuel electrode and of oxygen or air to the oxidant electrode. In order to induce the reaction, the solid polymer electrolyte fuel cell is generally configured by the ion exchange membrane; catalyst layers which are formed on both surfaces of the membrane and consist of a mixture including carbon particles supporting a catalyst substance thereon and a solid polymer electrolyte; gas diffusion layers (supply layers) made of a porous carbon material for the supply and the diffusion of fuel and oxidizing gas; and current collectors in the shape of a thin plate made of an electroconductive material such as carbon and metal.

In the recent years, a direct methanol fuel cell having the above configuration has been extensively developed in which organic liquid fuel such as methanol is directly supplied to the fuel electrode.

In the above configuration, the fuel supplied to the fuel electrode after passing through the fine pores in the gas diffusion layer reaches the catalyst by which the fuel is decomposed to generate electrons and hydrogen ions. The electron is introduced to an external circuit after passing through the catalyst support and the gas diffusion layer of the electrode, and flows into the oxidant electrode. On the other hand, the hydrogen ion reaches the oxidant electrode through the solid polymer electrolyte in the electrode and the solid polymer electrolyte membrane sandwiched between the both electrodes, and then forms water by means of the reaction with oxygen supplied to the oxidant electrode and the electrons flowing from the external circuit. As a result, the electrons flow from the fuel electrode toward the oxidant electrode in the external circuit to take out electric power.

However, the cell voltage of the single solid polymer fuel cell having the basic configuration corresponds to the difference between the redox potentials of the respective electrodes so that even the ideal open-circuit voltage is 1.23 V at the highest. This cell output is not necessarily sufficient for the driving power source mounted on various devices. For example, most of portable devices mounting the fuel cell as the driving power source require an input voltage of about 1.5 to 4V or more for their power sources. Accordingly, unit cells are required to be connected in series to elevate the cell voltage.

While the unit cells may be stacked to secure the sufficient voltage for realizing the elevated cell voltage, the stacked unit cells are not preferable as the driving power source of a portable device requiring a thin configuration because the thickness of the entire cell increases by the stacking.

A configuration may be suggested in which a plurality of unit cells connected in series are disposed on a single plane. However, in this configuration, a wiring is necessary for connecting the cells to increase the cell size and to lower the degree of the cell integration.

JP-A-2002-110215 discloses a fuel cell in which a plurality of unit cells are disposed on a single solid electrolyte membrane, and electrodes are connected to each other by via-holes. In the fuel cell having the configuration, the unit cells can be efficiently integrated to realize the miniaturization and the weight-saving of the fuel cell.

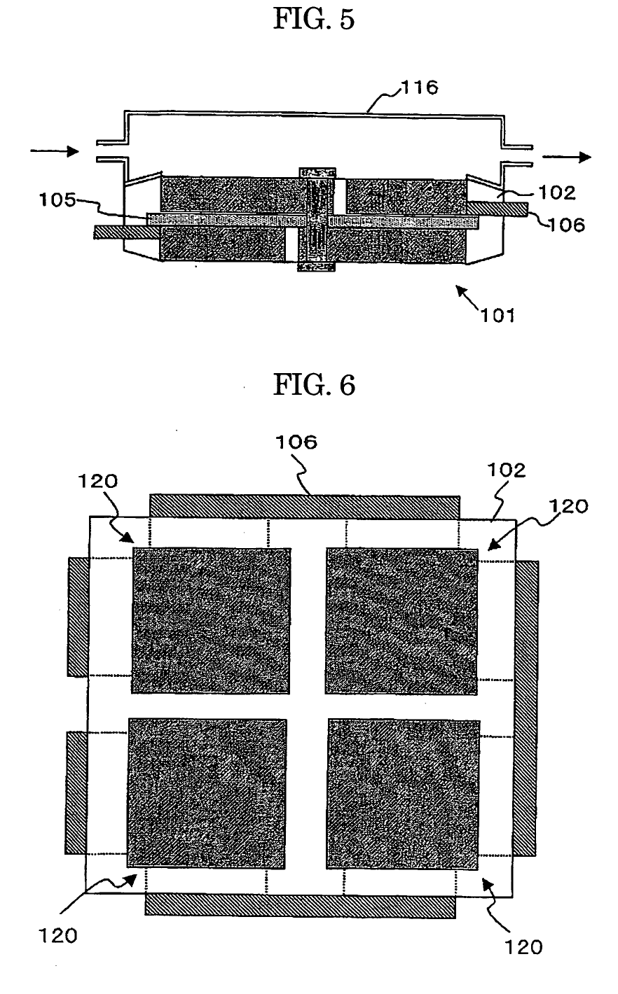

However, a current collecting plate mounted on the rear of a catalyst layer in a conventional fuel cell significantly restricts the above miniaturization and the weight-saving of the fuel cell. For example, in the above publication, an ion-conducting plate is mounted as a current collector for a Pt-porous electrode (FIG. 5 and paragraph 0003). In a conventional fuel cell electrode, a catalyst layer is formed on the surface of a gas diffusion layer having carbon material as a support, and a current collector is disposed to increase the current collecting efficiency of generated electrons.

The current collector requires a certain degree of thickness to achieve its function. Accordingly, the fuel cell has a problem that the size in the direction of its thickness is enlarged.

When a plurality of the electrodes are disposed on the solid electrolyte membrane, sufficient adhesion is required between the solid electrolyte membrane and the electrodes. The insufficient adhesion therebetween causes leak-out of fuel and leakage of current.

### DISCLOSURE OF INVENTION

### Problems to be Solved by Invention

The present invention has been made in view of the above circumstance. An object thereof is to intend the miniaturization, the thin structure and the weight-saving of a fuel cell in addition to the higher integration of unit cells.

Another object of the present invention is to provide a fuel cell with higher reliability which suppresses leak-out of fuel and leakage of current.

### Means for Solving Problems

In accordance with the present invention, a fuel cell is provided which includes a solid electrolyte membrane; a first electrode sheet including a plurality of first electrodes disposed on a single plane on one surface of the solid electrolyte membrane, and a resin section surrounding and supporting the first electrodes; and a plurality of second electrodes disposed on the other surface of the solid electrolyte membrane, opposing to the first electrode and sandwiching the solid electrolyte membrane with the first electrodes; wherein at least part of unit cells including the first electrodes and the second electrodes opposing to each other and the solid electrolyte membrane are connected in series by an electroconductive member penetrating the solid electrolyte membrane. In the present invention, the first electrode is a fuel electrode or an oxidant electrode, and the second electrode is the oxidant electrode or the fuel electrode.

The electroconductive member in the fuel cell can be mounted to connect the fuel electrode of a certain unit cell to the oxidant electrode of an adjacent unit cell.

The present invention employs the configuration in which a plurality of the fuel electrodes and a plurality of the oxidant electrodes are disposed on the respective single planes. The fuel electrodes are disposed on one side of the solid electrolyte membrane and the oxidant electrodes are disposed on the other side. The first electrode sheet including the plurality of the first electrodes (fuel electrodes or oxidant electrodes) disposed on the single plane, and the resin section surrounding and supporting the plurality of the first electrodes is disposed on at least one side of the solid electrolyte membrane. This configuration employed in the present invention can intend the miniaturization, the thin structure and the weight-saving of the fuel cell in addition to the higher integration of the unit cells.

Further, the oxidant electrodes and the fuel electrodes can be precisely disposed on the solid electrolyte membrane in accordance with a designed pattern. When both of the fuel electrodes and the oxidant electrodes are attached to the respective sheets, the alignment thereof can be conducted easily and precisely. Accordingly, the reliability of the fuel cell can be significantly elevated.

In the present invention, the electroconductive member penetrating the solid electrolyte membrane secures the electric connection between the adjacent cells. The fuel electrodes and the oxidant electrodes are connected to each other by the electroconductive member penetrating the solid electrolyte membrane. Accordingly, the member connecting the cells can be mounted with a minimum space so that the integration of the cells and the miniaturization of the fuel cell can be achieved.

The electroconductive member can be disposed in contact with porous metal which may constitute the respective electrodes. In this case, no current collecting plate is required. That is, the configuration in which the electroconductive member is connected to the fuel electrodes and the oxidant electrodes through no current collecting plate. Accordingly, the miniaturization, the thin structure and the weight-saving of the fuel cell can be achieved more significantly.

While, typically, carbon fibers such as carbon paper is heretofore used as a member constituting the electrode, the porous metal is desirably used as a support for the catalyst in the present invention. The support made of the metal of which an electric resistance is lower than that of carbon sufficiently functions as a cell electrode without the current collecting plate.

While the electroconductive member may be mounted in direct contact with the fuel electrode or the oxidant electrode, it can be connected to the porous metal through a metal member formed on the periphery of the porous metal. For example, the metal member is positioned along the periphery of the fuel electrode or the oxidant electrode, and the electroconductive member may be disposed in contact with the metal member.

The first and the second electrodes constituting the first and the second electrode sheets, respectively, may include the metal support and the catalyst supported thereon. A configuration may be employed in which a catalyst-resin film containing particles having the catalyst thereon, and hydrogen-ion conducting resin is adhered on the porous metal. Another configuration may also be employed in which a plated layer containing the catalyst is formed on the porous metal. The electroconductive particles supporting the catalyst may be catalyst particles themselves such as platinum particles or may be electroconductive particles supporting the catalyst such as carbon particles supporting platinum. The surface of the carbon material such as carbon paper constituting a conventional fuel cell is hydrophobic, and making the hydrophilic surface is difficult. On the other hand, the surface of the porous metal employable in the present invention is more hydrophilic than that of the carbon material. Accordingly, when liquid fuel containing methanol and water is supplied to the fuel electrode, the permeation of the liquid fuel into the fuel electrode is more accelerated than in a conventional electrode. Accordingly, the fuel supply efficiency can be elevated.

Further, at least part of the porous metal may be hydrophobically treated in the present invention. While the surface of the porous metal is more hydrophilic than that of the carbon material, the hydrophobic treatment can easily generate the hydrophilic region and the hydrophobic region in the electrode. The hydrophobic region in the oxidant electrode promotes the discharge of water in the oxidant electrode to suppress flooding. Accordingly, the higher output can be stably secured.

In the present invention, a configuration can be used in which the first and the second electrode sheets are disposed on both surfaces of the solid electrolyte membrane, and the peripheries of the pair of the electrode sheets are sealed to incorporate the solid electrolyte membrane therein. In accordance with this configuration, the problems regarding the fuel leak-out and the current leakage can be overcome.

Further, in accordance with the present invention, a method for fabricating a fuel cell can be provided which includes the steps of disposing, on both surfaces of a solid electrolyte membrane, a first electrode sheet including a plurality of first electrodes disposed on a single plane, and a resin section surrounding and supporting the first electrodes; and a second electrode sheet including a plurality of second electrodes disposed on a single plane, and a resin section surrounding and supporting the second electrodes; and thermally pressing the electrode sheets to seal peripheries thereof.

In the step of the above thermal pressing, the electroconductive member connecting the porous metals and existing on the respective surfaces of the solid electrolyte membrane can be formed by thermally pressing the electrode sheets in the state that the electroconductive member is disposed in a position where the first electrodes and the second electrodes sandwiching the solid electrolyte membrane are overlapped for sealing the peripheries of the pair of the electrode sheets.

Various configurations can be used in the step of forming the electroconductive member. For example, such a configuration may be used in which a rivet penetrates the stack including the porous metals and the solid electrolyte membrane, and the diameters of the top end and the bottom end of the rivet are enlarged to form the electroconductive member. In this manner, the pair of the fuel electrode and the oxidant electrode opposing to each other are connected by means of the electroconductive member penetrating the solid electrolyte membrane. Thereby, the fuel cell having the integrated cells can be stably fabricated.

In accordance with the above fabrication method, the fuel cell can be stably fabricated which realizes the miniaturization, the thin structure and the weight-saving.

### Effect of Invention

As described, in accordance with the present invention, the solid polymer fuel cell can be provided which realizes the high output, the miniaturization and the weight-saving.

### Best Mode for Implementing Invention

The constitutions of the respective elements of the fuel cell in connection with the present invention will be described.

The solid electrolyte membrane has roles of separating the fuel electrode from the oxidant electrode and of moving hydrogen ion between the electrodes. Therefore, the solid polymer electrolyte membrane preferably has high hydrogen ion conductivity, and preferably has the chemical stability and the high mechanical strength. As the material configuring the solid polymer electrolyte membrane, organic polymers are preferably used having a strongly acidic group such as sulfone group, phosphate group, phosphone group and phosphine group, and a weakly acidic group such as carboxyl group. As the above organic polymers, aromatic ring-containing polymers such as sulfonated poly(4-phenoxybenzoyl-1,4-phenylene) and alkylsulfonated polybenzoimidazole; copolymers such as polystyrenesulfonic acid copolymer, polyvinylsulfonic acid copolymer, bridged alkylsulfonic acid derivative and fluorine-containing polymer made of fluorine resin skeleton and sulfonic acid; copolymers prepared by co-polymerizing acryl amide such as acryl amide-2-methylpropane sulfonic acid and acrylate such as n-butylmethacrylate; sulfone group-containing perfluorocarbon (Nafion (available from Du Pont, registered trademark), Aciplex (available from Asahi Kasei Corporation, registered trademark); carboxyl group-containing perfluorocarbon (Flemion S membrane (available from Asahi Glass Co., Ltd.)) can be exemplified.

The fuel electrode and the oxidant electrode have a configuration in which the catalyst is supported on a substrate. The porous metal such as metal foam and metallic nonwoven fabric, and the electroconductive substrate made of the carbon paper can be used for the substrate. The porous metal is preferable for obtaining the excellent property of current collection by the substrate.

Stainless steel (SUS), nickel, chromium, iron, titanium, and their alloys can be exemplified as a raw material for preparing the porous metal. These porous metals on which gold is plated can be used as the substrate. The porosity of the porous metal is 40% to 80%, for example.

A method of foaming the metal is exemplified for making the porous metal. Specifically, gas is blown into or a foaming agent is added into melt metal to make foams, and then the foamed metal is solidified. A water soluble binder, powder material and the foaming agent can be mixed, then foamed, dried and sintered to provide the porous metal.

For example, stainless steel and nickel are preferably used for the porous metal. Especially, the porous metal made of the stainless steel maintains excellent the resistance of the fuel electrode with respect to the fuel liquid so that the durability and the stability of the fuel cell can be improved.

Specific and various configurations are possible for the fuel electrode and the oxidant electrode. A configuration may be employed in which a catalyst-resin film containing particles having the catalyst thereon, and hydrogen-ion conducting resin are adhered on the porous metal. Another configuration may also be employed in which a plated layer containing the catalyst is formed on the porous metal.

Platinum, rhodium, palladium, iridium, osmium, ruthenium, rhenium, gold, silver, nickel, cobalt, lithium, lanthanum, strontium and yttrium are exemplified for the catalyst used in the fuel electrode and the oxidant electrode. One single metal or the combination of two or more metals among these metals can be used. The catalysts used in the fuel electrode and the oxidant electrode may be the same as or different from each other.

Carbon particles are preferably used for electroconductive particles when the catalyst is supported thereon. As the carbon particles, acetylene black (Denka Black (available from Denki Kagaku Kogyo K.K.), XC72 (available from Vulcan Corporation) and ketjen black are exemplified. The particle size of the carbon particles is, for example, 0.01 to 0.1 μm, and preferably 0.02 to 0.06 μm. Nano carbon material having a large specific surface area such as carbon nanotube, carbon nanohorn and carbon nanohorn aggregate can be used in place of the carbon material.

The material exemplified for the above solid electrolyte membrane can be used as the hydrogen-ion conducting resin. For example, sulfone-group containing perfluorocarbon (Nafion, available from Du Pont) and Aciplex (available from Asahi Kasei Corporation) can be preferably used.

While various methods can be used for fabricating the fuel electrode and the oxidant electrode by adhering the catalyst and the resin on the substrate, the following method can be used, for example. At first, the catalyst is supported on the carbon particles, that can be conducted in accordance with an impregnation method generally employed. Then, the fuel electrode or the oxidant electrode can be obtained by dispersing the carbon particles supporting the catalyst and solid polymer electrolyte particles in a solvent to make paste and applying the paste on the substrate followed by the drying. The particle size of the carbon particles is, for example, 0.01 to 0.1 μm. The particle size of the catalyst particles is, for example, 1 to 50 nm. The particle size of the solid polymer electrolyte particles is, for example, 0.05 to 1 μm. The carbon particles and the solid polymer electrolyte particles are used, for example, in a range between 2:1 and 40:1 in weight ratio. The solvent and solute in the paste are used, for example, in a range between 1:2 and 10:1 in weight ratio. While a method of applying the paste on the substrate is not especially restricted, such a method as brush application, spray application, and screen printing can be used. The paste is applied in the thickness about 1 μm to 2 mm. The fuel electrode or the oxidant electrode is fabricated by means of the thermal pressing after the application of the paste. While the heating temperature and the heating time during the thermal pressing are suitably selected depending on the material employed, the heating temperature can be 100 to 250° C. and the heating time can be 30 seconds to 30 minutes.

While the above configuration utilizes the catalyst supported on the carbon particles, a configuration using platinum particles themselves such as platinum black and another configuration directly supporting the catalyst on the substrate are possible.

In order to directly support the catalyst on the substrate, the metal acting as the catalyst is plated on the surface of the porous metal. A method for the catalyst supporting includes a plating method such as electroplating and electroless-plating and a deposition method such as vacuum deposition and chemical vapor deposition (CVD).

In case of the electroplating, the substrate is dipped in the aqueous solution containing the subject catalyst metal ion and, for example, a direct current voltage of about 1V to 10V is applied. Platinum can be plated, for example, in a current density of 0.5 to 2A/dm² after Pt(NH₃)₂ (NO₂)₂ or (NH₄)₂ PtCl₆ is added to an acidic solution of sulfuric acid, sulfamic acid or ammonium phosphate. When a plurality of metals are plated, the plating can be conducted at a desired ratio by adjusting the voltage in a certain concentration range where one of the metals is in a condition of diffusion control.

In case of the electroless plating, after a reducing agent such as sodium hypochrolite and sodium borohydride is added to an aqueous solution containing the subject catalyst metal ion such as Ni, Co and Cu ion, the substrate is dipped in the aqueous solution and heated to about 90 to 100° C.

The resin constituting the resin section is an injection-moldable material such as thermoplastic resin and elastomer (including rubber). It is appropriately selected depending on the heat-resisting temperature, the hardness and the intended use.

The fuel used in the fuel cell includes organic liquid fuel such as methanol, ethanol and diethylether and hydrogen-containing gas. The effects of the present invention are remarkable when the organic liquid fuel is used in the fuel cell.

Various electroconductive materials can be used for the electroconductive member. When the electroconductive member is made of a low resistance metal material with excellent malleability, it is easily fixed in the fuel cell and the electric connection with the electrodes can be increased by means of the deformation of the electroconductive member. The above effects can be obtained by using the electroconductive member as a rivet. Gold, silver, copper and aluminum are exemplified as the low resistance metal material with excellent malleability.

Embodiments of the present invention will be described referring to the annexed drawing.

### First Embodiment

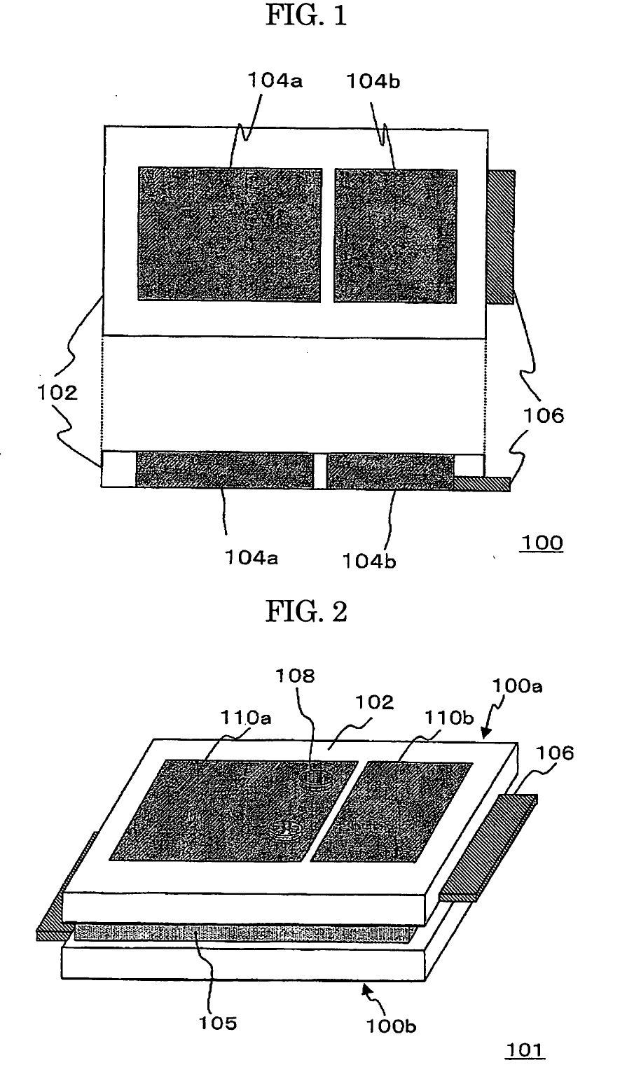

The present Embodiment exemplifies a fuel cell including two unit cells connected in series. FIG. 1 shows a schematic structure of an electrode sheet 100 constituting a fuel cell in accordance with the present Embodiment. In FIG. 1, the above drawing is an front elevation view and the bottom drawing is a side elevation view.

The electrode sheet 100 includes a plurality of electrodes 104a, 104b containing catalyst and disposed on a single plane, and a resin section 102 surrounding the electrodes. The electrode 104b is equipped with a draw-out electrode 106. The electrodes 104a, 104b are prepared by forming a catalyst layer on porous metal. While specific materials for forming the electrodes 104a, 104b and the resin section 102 are illustrated above, the electrodes 104a, 104b are made of foamed metal of SUS316 belonging to stainless steel and the resin section 102 is made of polyethylene in this Embodiment.

For example, the electrode sheet 100 can be fabricated as follows.

After foamed metal of SUS316 having a catalyst layer thereon is cut into specified shapes acting as insert components, insert molding is conducted thereon to provide the electrode sheet 100 having the electrodes 104a, 104b made of the porous metals and the resin section 102 integrated with each other.

An electroconductive metal thin plate (SUS316 thin plate in the Embodiment) is bonded to the end of the electrode 104b by means of welding to from the draw-out electrode 106 before the insert molding.

The specific procedures for the insert molding are as follows. After the electrodes as the insert components are placed in a cavity C formed between a pair of templates A, B as shown in FIG. 11, the electrode sheet 100 having the electrode 104a, the electrode 104b bonded with the draw-out electrode 106 and the resin section 102 integrated with one another is obtained by filling melt resin F injected from a runner D through a gate E, in the cavity C. Since the electrodes 104a, 104b are made of the porous metal, the melt resin impregnates in the pores on the sides of the electrodes 104a, 104b by a depth about 5 μm to 1000 μm, and hardens. Accordingly, the electrodes 104a, 104b and the resin section are strongly bonded with each other.

In case of using polyethylene for the resin section 102, the electrode sheet 100 can be obtained by means of the mold closing at a molding temperature of 180° C. and 80 kN followed by the injection molding at a molding pressure of 25 MPa.

In case of fabricating the electrode sheet 100 by the injection molding, the thickness (in the direction of opening and closing the mold) of the cavity C at the time of the mold closing is made smaller than the thickness of the electrodes 104a, 104b so that the electrodes 104a, 104b made of the porous metal are compressed by 3 to 90% between the templates A, B during the mold closing. Thereby, the electrodes 104a, 104b can be fixed in the cavity C and the degree of flatness of the electrodes 104a, 104b can be improved by the pressure of the injected resin.

When the pore diameter and the porosity of the porous metal of the electrodes 104a, 104b are too small, the melt resin cannot penetrate into the pores thereby providing the insufficient anchoring effect. Therefore, the sufficient bonding strength with the resin section cannot be obtained so that peel-off may be take place on the bonding part. On the other hand, the pore diameter and the porosity are too large, the strength comes short to generate deformation because the porous metal cannot endure the resin molding pressure and the compression during the resin hardening. It is, accordingly, preferable that the pore diameter of the porous metal constituting the electrodes 104a, 104b is about 10 μm to 2 mm and the porosity thereof is about 40 to 98%, and more preferably about 40 to 80%.

FIG. 2 shows a schematic structure of the fuel cell 101 using the electrode sheet shown in FIG. 1. In this structure, a pair of electrode sheets 100a, 100b sandwiching a solid electrolyte membrane 105 are disposed opposing to each other. The electrode sheet 100a includes fuel electrodes 110a, 100b, and the electrode sheet 100b includes oxidant electrodes acting as counter-electrodes of the fuel electrodes 110a and 110b. The fuel electrode 110a is connected to the oxidant electrode on the electrode sheet 100b through a rivet 108 made of gold acting as the electroconductive member. The draw-out electrode 106 is attached to the fuel cell 110b.

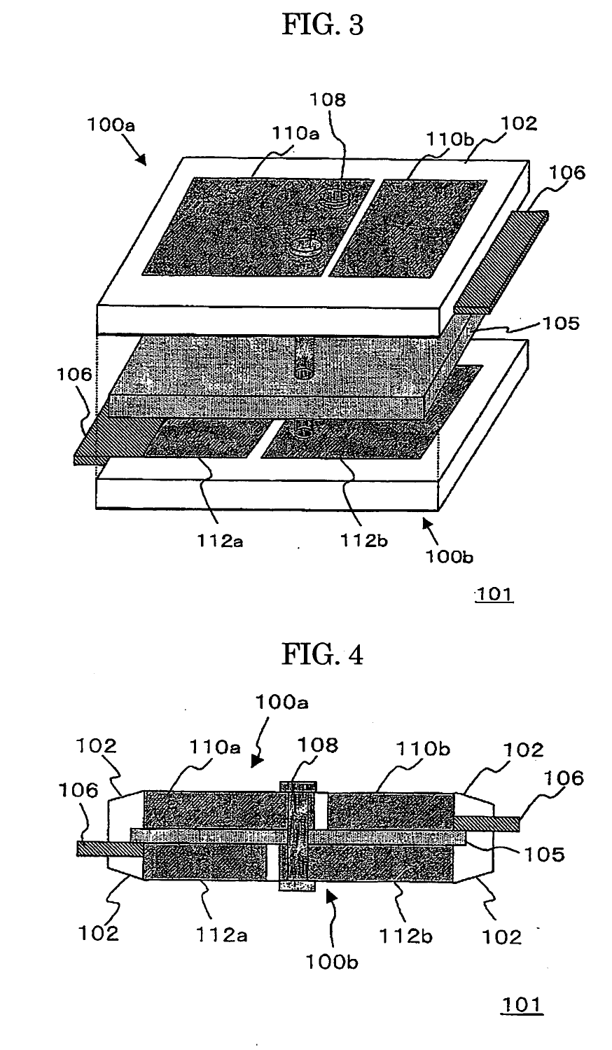

FIG. 3 shows the layer configuration of the fuel cell shown in FIG. 2. The fuel electrode 110a and an oxidant electrode 112b sandwiching the solid electrolyte membrane 105 are mounted in a positional relation that they are overlapped with each other. The rivet 108 made of gold is provided in the above overlapped position to penetrate the solid electrolyte membrane 105 thereby connecting the fuel electrode 110a and the oxidant electrode 112b.

In FIGS. 2 and 3, all of the fuel electrodes 110a, 10b and the oxidant electrodes 112a, 112b have a configuration that a catalyst layer is formed on the porous metal. As described earlier, foamed stainless steel or nickel can be used for the porous metal. Platinum or platinum-ruthenium can be preferably used as the catalyst. For example, the platinum and the platinum-ruthenium can be used as the catalysts of the oxidant electrode and of the fuel electrode, respectively. In this manner, the fuel cell with the excellent efficiency which suppresses decrease of the catalyst activity can be realized.

FIG. 4 is a sectional view of the fuel cell 101 shown in FIGS. 2 and 3 in which the fuel electrode 110a and the oxidant electrode 112a; and the fuel cell 110b and the oxidant electrode 112b constitute the respective unit cells. The fuel electrode 110a and the oxidant electrode 112a are electrically connected with each other so that the left-hand unit cell and the right-hand unit cell are electrically connected in series with each other. The respective electrodes are surrounded by the resin section 102. The peripheries of the upper electrode sheet and the lower electrode sheet sandwiching the solid electrolyte membrane 105 are sealed to incorporate the solid electrolyte membrane between these electrode sheets.

The fuel cell shown in FIGS. 2 to 4 can be fabricated as follows.

At first, the electrode sheets 100a, 100b including a plurality of the porous metals containing the catalyst and the resin section and disposed on a single plane are fabricated. Specifically, the above-described injection molding is used.

Then, the pair of the electrode sheets 100a, 100b fabricated above are disposed on the respective surfaces of the sold electrolyte membrane 105.

Then, the rivet 108 is disposed in a position where the fuel electrode 110a on the electrode sheet 100a and the oxidant electrode 112b on the electrode sheet 100b sandwiching the solid electrode membrane 105 are overlapped followed by hot-pressing. Thereby, the peripheries of the resin sections 102 of the respective electrode sheets are melted and bonded. The rivet 108a is made to penetrate the stack including the fuel electrode 110a, the solid electrolyte membrane 105 and the oxidant electrode 112b, and the top end and the bottom ends of the rivet are crushed to make their diameters larger. Thereby, the fuel electrode 110a and the electrode sheet 100b are connected with each other.

The conditions for the hot-pressing are selected depending on the material of the resin section 102. Ordinarily, the pressing is conducted at a temperature over the softening temperature and the glass transition temperature of the resin of the resin section. For example, the temperature of 100 to 250° C., a pressure of 1 to 100 kg/cm² and a pressing time of 10 to 300 seconds are illustrated.

FIG. 5 shows the fuel cell in FIGS. 2 to 4 equipped with a fuel vessel 116. The fuel vessel 116 can be made of, for example, thermoplastic resin such as polyethylene to be bonded to the resin section 102 constituting the fuel cell. Since the fuel electrodes are disposed on one side of the solid electrolyte membrane in the above fuel cell, the fuel can be supplied to a plurality of the unit cells from the single fuel vessel 116.

Since both of the fuel vessel 116 and the resin section 102 are made of the resin in the fuel cell of FIG. 5, the both components can be bonded without fail by means of thermal melt-bonding or an adhesive agent. Accordingly, the problem regarding the fuel leak-out from the bonded part between the fuel vessel and the fuel cell can be effectively solved.

In order to thermally melt and bond the fuel vessel 116 and the resin section 102, the same resin material is preferably used in both to improve the adhesion therebetween.

### Second Embodiment

In this Embodiment, a fuel cell including electrodes and cells in matrix on a single plane is exemplified.

Before the description of the fuel cell of the present Embodiment, the structure of a conventional fuel cell will be shown. FIG. 6 is an example of a conventional fuel cell in an electrode-connection system. In the fuel cell, unit cells 120 are disposed in “2×2” in a resin section 102. A draw-out electrode 106 is mounted and connected to two adjacent unit cells 120 outside of an electrolyte membrane. In the fuel cell shown therein, the four unit cells are connected in series to take out the total output.

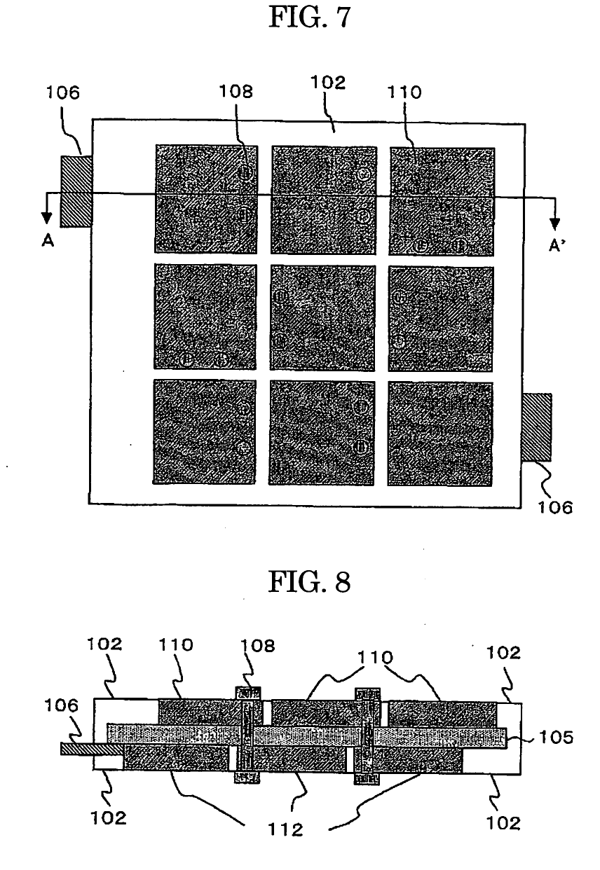

However, in this configuration, the draw-out electrodes outward extend around the resin section 102 so that there remains a problem regarding the miniaturization of the fuel cell and the higher integration. Further, since the respective unit cells are disposed along the respective edges of the resin section, each of the unit cells can be connected to the draw-out electrode. However, in the fuel cell disposition in “3×3” illustrated in FIG. 7, the central cell is hardly connected to the draw-out electrode.

FIGS. 7 and 8 show a configuration of a fuel cell in accordance with the present Embodiment. FIG. 7 is a top plan view showing the fuel cell of the present Embodiment, and FIG. 8 is its sectional view.

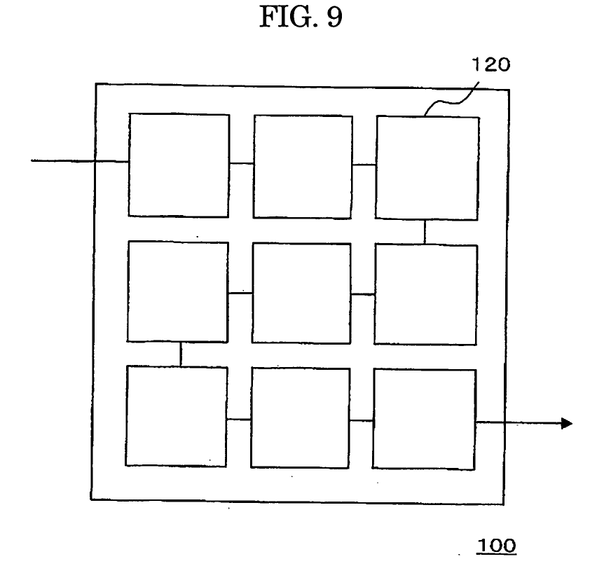

As shown in FIG. 7, unit cells are disposed in a “3×3” matrix on a single plane, and the adjacent unit cells are connected with each other by rivets 108 in the fuel cell. The connection system is the same as that of Embodiment 1 so that the rivet 108 penetrating a sold electrolyte membrane 105 and in contact with a pair of top and bottom electrodes produces the electric connection (FIG. 8). As shown, the top electrode 110 and the bottom electrodes 112 are disposed to be overlapped, and the rivet 108 is positioned in the overlapped part. As shown in FIG. 9. such a connecting component provides a configuration in which nine unit cells 120 are connected in series in this fuel cell.

The configurations of the fuel electrode 110 and the oxidant electrode 112 are the same as those of Embodiment 1, and the catalyst layer is formed on the foamed porous metal such as stainless steel.

In accordance with the present Embodiment, the electric connection to the unit cell which is not in contact with the edge of the resin section 102 can be secured so that the integration of the fuel cell is significantly improved. No margin is required for making the electric connection to promote the further miniaturization of the fuel cell. The leak-out of the fuel and the leakage of the current can be effectively prevented in the fuel cell shown in FIG. 8 because all the peripheries of the fuel electrode 110 and the oxidant electrode 112 are surrounded by the resin section 102 to provide a structure in which the top and the bottom electrode sheets sandwiching the solid electrolyte membrane 105 are sealed by the melt-bonding of the resin section 102.

The surface of the porous metal used in the present Embodiment is more hydrophilic than that of carbon material. When, accordingly, liquid fuel containing water and methanol is supplied to the fuel electrode, the permeation of the liquid fuel into the fuel electrode is promoted compared with a conventional electrode. Accordingly, the supply efficiency of the fuel can be improved.

### Third Embodiment

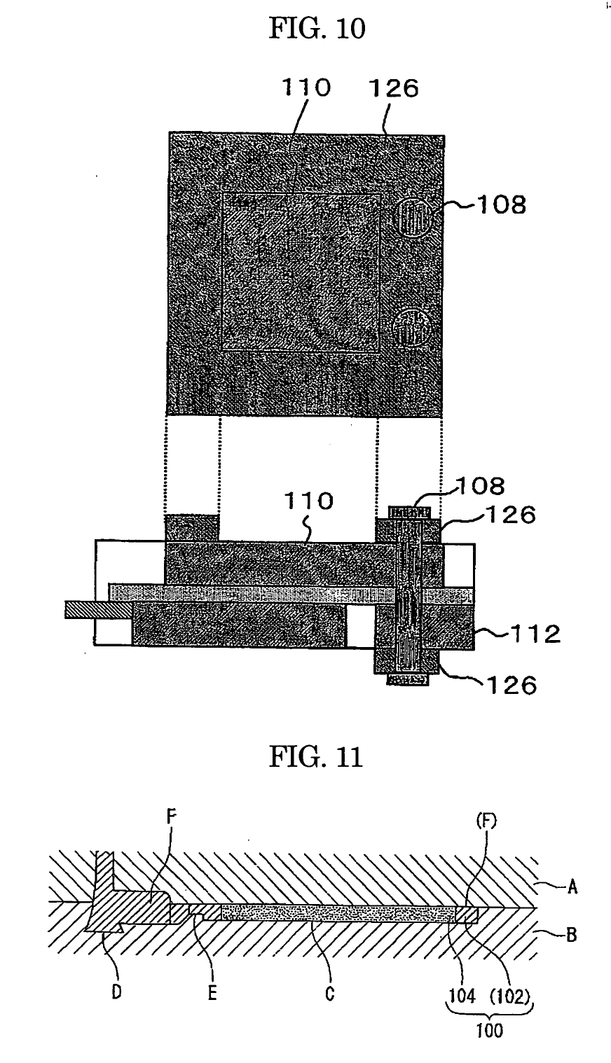

In the present Embodiment, as shown in FIG. 10, a metal frame 126 is disposed along the peripheries of the fuel electrode 110 and the oxidant electrode 112, and the rivet 108 is positioned through the metal frame to connect the cells. In this manner, a contact resistance between the rivet 108 and the cell can be reduced.

### EXAMPLE 1

The fuel cell shown in FIG. 1 was fabricated using the following electrode sheet.
Electrode: Porous substrate made of foamed SUS316 (porosity: 60%)
Catalyst: Platinum for oxidant electrode, platinum (Pt)-ruthenium (Ru) alloy for fuel electrode
Material of rivet: Gold
Resin constituting electrode sheet: Polyethylene

Catalyst-supported carbon particles prepared by supporting catalyst on the carbon particles (Denka Black, available from Denki Kagaku Kogyo K.K.) were used. Catalyst paste was prepared by adding 18 ml of 5 wt % Nafion solution available from Aldrich Chemical Co. to 1 g of the above catalyst-supported carbon particles followed by the agitation with an ultrasonic agitator at 50° C. for three hours. The paste was applied on the porous substrate by using a screen printing method followed by the drying at 120° C., thereby providing an electrode.

A solid polymer electrolyte membrane (Nafion (registered trademark) available from Du Pont, membrane thickness: 150 μm) was sandwiched between a pair of the electrode sheets previously fabricated, and thermally bonded under pressure. At the same time, a gold rivet was disposed in the position specified in FIG. 1 to connect the electrodes to each other.

A fuel vessel made of resin such as polypropylene and polyethylene was attached to the fuel electrode side to provide the structure shown in FIG. 5.

Then, 10% methanol aqueous solution was flown in the fuel cell at a rate of 2 ml/min. When the cell characteristic were measured while the outer surface of the fuel cell was exposed to air, a cell voltage at a current density of 100 mA/cm² was 0.8V. This voltage corresponded to twice the voltage measured in a single unit cell so that the two unit cells were confirmed to be connected in series.

Since the above Embodiments and Example are described only for examples, the present invention is not limited to the above embodiments and various modifications or alternations can be easily made therefrom by those skilled in the art without departing from the scope of the present invention.

### BRIEF DESCRIPTION OF DRAWINGS

[FIG. 1] FIG. 1 shows a schematic structure of an electrode sheet constituting a fuel cell in accordance with first Embodiment.

[FIG. 2] FIG. 2 shows a schematic structure of the fuel cell using the electrode sheet shown in FIG. 1.

[FIG. 3] FIG. 3 shows the layer configuration of the fuel cell shown in FIG. 2.

[FIG. 4] FIG. 4 is a sectional view of the fuel cell shown in FIGS. 2 and 3.

[FIG. 5] FIG. 5 shows the fuel cell in FIGS. 2 to 4 equipped with a fuel vessel.

[FIG. 6] FIG. 6 is an example of a conventional fuel cell in an electrode-connection system.

[FIG. 7] FIG. 7 is a top plan view showing the fuel cell of second Embodiment.

[FIG. 8] FIG. 8 is a sectional view of FIG. 7.

[FIG. 9] FIG. 9. shows a connection between cells in a fuel cell of second Embodiment.

[FIG. 10] FIG. 10 shows a connecting component between cells in third Embodiment.

[FIG. 11] FIG. 11 is an illustration showing a method of forming an electrode sheet.

### DESCRIPTION OF SYMBOLS

100 electrode sheet
102 resin section
104 electrode
105 solid electrolyte membrane
106 draw-out electrode
108 rivet
110 fuel electrode
112 oxidant electrode
116 fuel vessel
120 unit cell
126 metal frame

1. A fuel cell comprising:
a solid electrolyte membrane;
a first electrode sheet including a plurality of first electrodes disposed on a single plane on one surface of the solid electrolyte membrane, and a resin section surrounding and supporting the first electrodes; and
a plurality of second electrodes disposed on the other surface of the solid electrolyte membrane, opposing to the first electrode and sandwiching the solid electrolyte membrane on the other surface of the solid electrolyte membrane;
wherein at least part of unit cells including the first electrodes and the second electrodes opposing to each other and the solid electrolyte membrane are connected in series by an electroconductive member penetrating the solid electrolyte membrane.

2. The fuel cell as claimed in claim 1, wherein the plurality of second electrodes constitute a second electrode sheet together with a resin section surrounding and supporting the second electrodes.

3. The fuel cell as claimed in claim 1, wherein the first electrodes in the electrode sheet each include porous metal and a catalyst supported on the porous metal.

4. The fuel cell as claimed in claim 3, further comprising a catalyst-resin film containing particles having the catalyst thereon and hydrogen-ion conducting resin which is adhered on the porous metal.

5. The fuel cell as claimed in claim 3, further comprising a plated layer containing the catalyst which is formed on the porous metal.

6. The fuel cell as claimed in claim 3, wherein at least part of the porous metal is hydrophobically treated.

7. The fuel cell as claimed in claim 1, wherein the first electrodes constitute a fuel electrode and the second electrodes constitute an oxidant electrode.

8. The fuel cell as claimed in claim 7, wherein a periphery of the pair of the electrode sheets is sealed to incorporate the solid electrolyte membrane therein.

9. The fuel cell as claimed in claim 1, wherein a current collector is embedded in the resin section to be connected to the first electrodes and/or the second electrodes.

10. The fuel cell as claimed in claim 1, wherein the electroconductive member is connected to the first electrodes and the second electrodes without an intervening current collecting plate.

11. A method of fabricating a fuel cell comprising the steps of:
disposing, on both surfaces of a solid electrolyte membrane, a first electrode sheet including a plurality of first electrodes disposed on a single plane and a resin section surrounding and supporting the first electrodes, and a second electrode sheet including a plurality of second electrodes disposed on a single plane and a resin section surrounding and supporting the second electrodes; and
thermally pressing the pair of electrode sheets to seal peripheries thereof.

12. The method of fabricating the fuel cell as claimed in claim 11, wherein the thermally pressing step is such that the pair of electrode sheets are thermally pressed in a state that the electroconductive member is disposed in a position where the first electrodes and the second electrodes sandwiching the solid electrolyte membrane are overlapped, thereby sealing the peripheries of the pair of the electrode sheets and forming the electroconductive member connecting porous metals to each other on the respective surfaces of the solid electrolyte membrane.

13. The method of fabricating the fuel cell as claimed in claim 12, wherein the electroconductive member forming step includes the steps of allowing an electroconductive rivet to penetrate a stack including the porous metals and the solid electrolyte membrane, and enlarging diameters of top end and bottom end of the rivet.

14. The method of fabricating the fuel cell as claimed in claim 11, wherein the first electrodes and/or the second electrodes each include the porous electrode and a catalyst supported thereon.
